(19) United States
(12) Patent Application Publication
(10) Pub. No.: US 2009/0300054 A1
(43) Pub. Date: Dec. 3, 2009

(54) SYSTEM FOR INFERRING DATA STRUCTURES

(76) Inventors: Kathleen Fisher, Los Altos, CA (US); Edward David Burke, Tigard, OR (US); David Walker, Princeton, NJ (US); Peter Duncan White, Beaverton, OR (US); Kenny Qili Zhu, Plainsboro, NJ (US)

Correspondence Address: AT&T Legal Department - JW;Attn: Patent Docketing, Room 2A-207, One AT&T Way, Bedminster, NJ, 07921, US

(21) Appl. No.: 12/183,409

(22) Filed: Jul. 31, 2008

Related U.S. Application Data
(60) Provisional application No. 61/057,125, filed on May 29, 2008.

(51) Int. Cl. G06F 17/30

(52) U.S. Cl. 707/102; 707/E17.009

(57) ABSTRACT

A system is disclosed for formulating structure descriptions from data. In some embodiments, data arrives with an unknown format. The data may be ad hoc data that is considered semi-structured. Disclosed embodiments analyze chunks of the data to determine tokens. Tokens are analyzed to identify base types and compound types such as structs, unions, and arrays. Descriptions are generated and undergo scoring and rewriting for optimization. The generated descriptions may be fed to a data description language such as Processing Ad Hoc Data System (PADS) and compiled for processing the raw data. In some embodiments, the raw data is parsed, printed, or reformatted using the generated descriptions.

### FEDERALLY SPONSORED RESEARCH

This invention was made with Government support under DARPA grant FA8750-07-C-0014 and NSF grants 0612147 and 0615062. The Government may have certain rights to this invention.

### BACKGROUND

1. Field of the Disclosure

The present disclosure generally relates to software change management and, more particularly, to systems and methods for inferring data structures, particularly in ad hoc data.

2. Description of the Related Art

Information stored in data files may be accessed for analysis, printing, and reformatting. If the structure, arrangement, or format of the information within the data file is unknown, the data file may require initial processing and examination before the information can be accessed.

### BRIEF DESCRIPTION OF THE DRAWINGS

FIG. 1 illustrates selected components of a format inference architecture for determining data structures from raw data files;

FIG. 2 illustrates additional components of an architecture for determining data structures from raw data files, including additional details regarding a structure inference module;

FIGS. 3A, 3B, 3C, 3D, and 3E illustrate examples of raw, ad hoc data that may be processed by disclosed embodiments to determine the data structure of the data;

FIG. 4 illustrates an example algorithm that outlines a procedure for structure discovery in Pseudo-ML (i.e., pseudo meta-language);

FIG. 5 illustrates histograms that may be generated and analyzed as part of structure discovery for raw data;

FIGS. 6A and 6B depict a selection of rewriting rules that may be used in the refinement phase of determining data structures;

FIG. 7 illustrates selected aspects of a methodology for determining the data structure for ad hoc data; and

FIG. 8 depicts in block diagram form a data processing system for use with disclosed embodiments.

### DESCRIPTION OF THE EMBODIMENT(S)

In one aspect, an application server is disclosed that is enabled for inferring a data structure by analyzing the data. The application server generates a format specification based on the inferred structure of the data. The format specification complies with a data description language. In some embodiments, the data includes ASCII data and the application server is enabled to compile the format specification to produce a format-dependent executable module. Additionally, the application server may be enabled with a tokenization agent for discovering how a plurality of fields is defined within each of a portion of a plurality of chunks that comprise the data. The application server may further be enabled with a structure discovery agent for determining characteristics related to a portion of the plurality of fields and a scoring function agent for grading the format specification. The format refinement agent, in some embodiments, iteratively modifies the format specification into a version of the modified format specification. The version is presented to the scoring function agent for analysis of the version and a determination is made for an optimal format specification based on analysis by the scoring function agent. The format-dependent executable module may be an Extensible Markup Language module. In addition, the format specification may be suitable for use by a data parser, a data printer, or a data description compiler. The data description compiler may be a Processing Ad Hoc Data Sources (PADS) compiler.

In another aspect, a method is disclosed for determining data structures. The method includes receiving raw data arranged into a plurality of chunks. The chunks include a plurality of fields that are separated by a plurality of instances (i.e., occurrence counts) of a delimiter. A delimiter is a character or sequence of characters that specify the boundaries between separate, independent regions in a data record or data stream. Commas, white spaces, tabs, semicolons, slashes, and colons are illustrative examples of delimiters. If raw data is arranged with new chunks on each line, commas may act between fields as a delimiter (i.e., field delimiter), and the fields between the delimiters may be referred to as comma-separated values. The method includes determining a quantity of the plurality of instances of the delimiter for a portion of the plurality of chunks. Further, the method provides for determining whether there are corresponding fields in the portion of the plurality of chunks. If there are corresponding fields in the portion of the plurality of chunks, illustrative embodiments may determine whether a threshold number of entries have the same data class. Some embodiments may use recursive analysis to find structure in a data source. As an example, some embodiments may determine during a first iteration of analysis that a data source is characterized by a top-level delimiter, such as a comma, that demarcates sub-problems. During one or more subsequent iterations, the analysis may identify characteristics of each of the sub-problems, e.g., the first sub-problem is characterized as a character or integer while the second sub-problem is characterized as an integer or character string. Recursive analysis contributes to methods successfully analyzing both tree-structured data and flat lists.

In an additional aspect, a computer program product for determining data formats is disclosed. The computer program product is stored on computer readable media and includes instructions operable for lexing raw data to result in a plurality of tokens. The raw data may be understood to be arranged in a plurality of chunks. Each chunk contains a plurality of corresponding fields. Instructions are operable for, on a field-by-field basis for a portion of the plurality of chunks, summing the instances of an ASCII character to result in a plurality of sums. Further instructions are operable for determining from the plurality of sums whether each chunk of the portion of the plurality of chunks has a threshold number of instances of the ASCII character. If each of the plurality of chunks has a first threshold number of instances of the ASCII character, instructions are operable for including in a description a first indication that the ASCII character is a delimiter. Further instructions provide for determining for the portion of the plurality of chunks whether a second threshold number of instances of a data class occurs within corresponding entries of a field. Regarding the determining instructions, in some embodiments, each corresponding entry is from a different portion of the plurality of chunks. If a second threshold number of instances of a data class occur within corresponding entries of the field, instructions provide for including in the description a second indication that entries in the field are from the data class.

In the following description, for the purposes of explanation, numerous specific details are set forth in order to provide a thorough understanding of the disclosed embodiments. A person of ordinary skill in the art should recognize that embodiments may be practiced without some of these specific details. In other instances, well-known structures and devices may be shown in block diagram form or omitted for clarity. A published paper entitled “From Dirt to Shovels: Fully Automatic Tool Generation from Ad Hoc Data” by Kathleen Fisher, et al., has detailed discussions regarding much of the subject matter herein. Accordingly, this paper is incorporated by reference in its entirety.

An ad hoc data source may be any semi-structured data source for which useful data analysis and transformation tools are not readily available. Common characteristics of ad hoc data make it somewhat challenging to perform basic data-processing tasks. To start, data analysts typically have little control over the format of the data because it arrives “as is” and the analysts cannot typically request a more convenient format. Any documentation that accompanies ad hoc data is often incomplete, inaccurate, or missing entirely, which makes understanding the data format more difficult. Managing the errors that frequently occur when processing the data poses another challenge. Common errors include undocumented fields, corrupted or missing data, and multiple representations for missing values. Sources of errors include malfunctioning equipment, race conditions on log entry, the presence of non-standard values to indicate “no data available,” and human error when entering data, as examples. How to respond to errors is highly application-specific: Some need to halt processing and alert a human operator; others can repair errors by consulting auxiliary sources; still others simply filter out erroneous values. In some cases, erroneous data is more important than error-free data. For example, erroneous data may signal where two systems are failing to communicate. Unfortunately, writing code that reliably handles both error-free and erroneous data is difficult and tedious.

To infer the format of the data, disclosed embodiments may use machine-learning techniques to generate a canonical XSchema (e.g., an XML schema for defining the structure, content, and semantics of XML documents). The data may then be converted into XML that conforms to the generated schema. Disclosed embodiments are therefore intended to allow for correctly and efficiently learning the structure of a variety of formats and outputting XML, for example. A significant aspect of some disclosed embodiments regards their ability to automatically read text-based, ad hoc data formats that may include both payload and punctuation. With such text-based, ad hoc data formats, disclosed embodiments may measure the regularity of the punctuation in determining the structure of the data. The regularity can be detected by considering and analyzing chunks, which are multiple positive instances of the data. Chunks may comprise each line in a log file, for example. Alternatively, chunks are stored in separate files that ideally share the same format or structure. Disclosed embodiments may utilize several phases in inferring the format of an ad hoc data source. Key phases may include tokenization, structure discovery, and iterated structure refinement. Iterated structure refinement may be guided by an information-theoretic scoring function.

Data sources arranged according to Extensible Markup Language (XML), Hypertext Markup Language (HTML), or comma-separated values (CSV) are not typically ad hoc data sources as there are numerous programming libraries, query languages, manuals and other resources dedicated to helping analysts manipulate data in these formats. However, despite the prevalence of standard formats, a large amount of legacy ad hoc data persists in fields such as computational biology, finance, physics, healthcare, and systems administration. Disclosed embodiments help to automatically analyze ad hoc data and to create, from the ad hoc data itself, useful data processing tools including semi-structured query modules, format converters, statistical analyzers, printers, and data visualization routines.

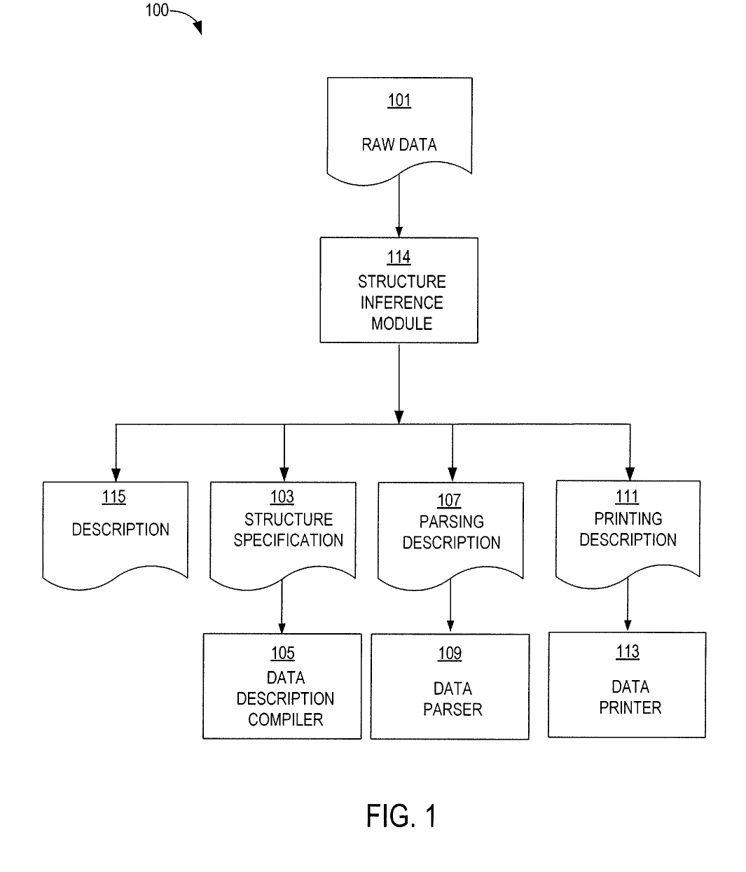

FIG. 1 illustrates format inference architecture 100 with selected elements for inferring data structures in accordance with disclosed embodiments. As shown, structure inference module 114 receives raw data 101. Raw data 101 may be arranged into a plurality of chunks that include a plurality of fields that are separated by a plurality of instances of a delimiter. Structure inference module 114, in some embodiments, determines a quantity of the plurality of instances of the delimiter for a portion of the plurality of chunks. In addition, structure inference module 114 may determine whether there are corresponding fields in the portion of the plurality of chunks. If there are corresponding fields in the portion of the plurality of chunks, structure inference module 114 determines whether a threshold number of entries have the same data class. In some embodiments, the threshold number of entries are from individual fields of a portion of the corresponding fields.

After inferring the structure of raw data 101, structure inference module 114 may create one or more descriptions including structure description 103. In some embodiments, structure description 103 may include a plurality of description entries that specify a data class for an individual of the corresponding data fields in raw data 101. As shown in FIG. 1, structure description 103 is presented to data description compiler 105, which may be a PADS compiler, for example. Accordingly, in some embodiments, structure description 103 is a PADS description generated by structure inference module 114 that may be used for processing raw data 101. Data description compiler 105 may generate tools for printing, parsing, and other such functions.

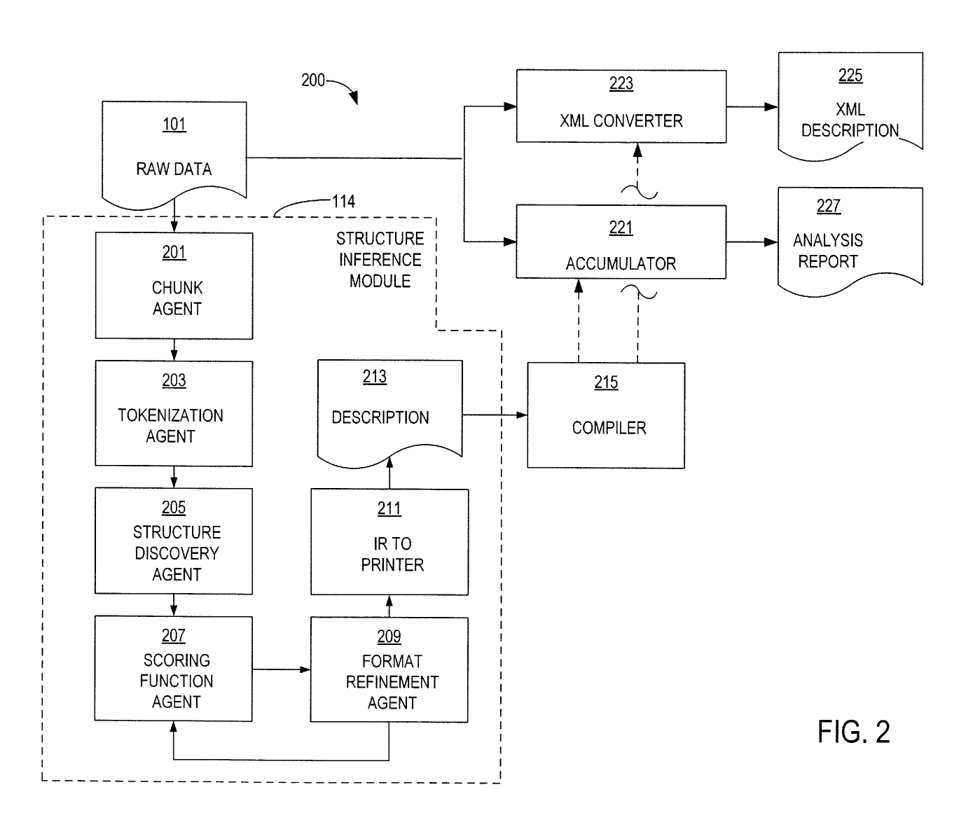

FIG. 2 illustrates format inference architecture 200 for inferring a format for ad hoc data in accordance with disclosed embodiments. Some elements in FIG. 2 are identical to or similar to elements in FIG. 1, as suggested by use of corresponding element numbers. As shown in FIG. 2, raw data 101 is communicated to structure inference module 114. Structure inference module 114 produces a description 213 for raw data 101 through a series of processes including chunking, tokenization, structure discovery, information-theoretic scoring, and structure or format refinement. Structure inference module 114 then feeds the generated description 213 into compiler 215. In some embodiments, description 213 is a PADS description and compiler 215 is a PADS compiler description. Compiler 215 may generate libraries, which format inference architecture 200 then links to generic programs for various tasks including a data analysis tool (e.g., accumulator 221) and an ad-hoc translator (e.g., XML converter 223). As shown, XML converter 223 translates ad hoc data (e.g., raw data 101) to XML description 225. Similarly, accumulator 221 translates ad hoc data into analysis report 227. Users may apply generated description 213 to the original raw data 101 or to other data with the same format. The following describes the components of structure inference module 114 in more detail.

As shown in FIG. 2, chunking of raw data 101 is performed by chunk agent 201 and tokenization is performed by tokenization agent 203. In operation, chunk agent 201 may first divide the raw data 101 into user specified chunks. Typically, a chunk is a unit of repetition in a data source such as raw data 101. It is primarily by analyzing sequences of such chunks for commonalities that the structure inference module 114, including chunk agent 201, is able infer data descriptions (e.g., description 213). In many cases, raw data is assumed to be presented in line-by-line basis. In other words, each line in a multi-line data file (e.g., raw data 101) contains a record or data set. In some cases, raw data (e.g., raw data 101) is arranged in a file-by-file base. In still other cases, two lines in a raw data file may represent a chunk, and this may be inferred by chunk agent 201's analysis or by a user manually specifying such characteristics to chunk agent 201. Disclosed embodiments herein may assume that raw data is arranged in chunks on a line-by-line basis; however, such embodiments are illustrative and not meant to be restrictive.

After the arrangement of chunks in raw data 101 is discovered or possibly confirmed by chunk agent 201, tokenization agent 203 may be used to break each chunk into a series of simple tokens (e.g., lexemes). A token may be any block of text categorized according to base type, meaning, or function, as examples. Tokens are frequently defined by regular expressions, which are understood by a lexical analyzer or lexer. Some basic examples of tokens include integers, white spaces, punctuation, and text strings. Tokens that may be more distinctive include IP addresses, dates, times, media access control (MAC) addresses, and the like. The block of text that corresponds to a token may be referred to as a lexeme. A lexeme may be any string of characters known to be of a certain kind (e.g., a string literal, a sequence of letters, an integer, and a float). Tokens may be “atomic” pieces of data such as numbers, dates, times, alpha-strings, or punctuation symbols. In accord with disclosed embodiments a tokenization agent 203 may operate as a lexical analyzer that processes lexemes and categorizes them according to base type, function, or meaning. This assignment may be referred to as “tokenizing” or “tokenization.” Accordingly, a lexical analyzer such as tokenization agent 203 may read in a stream of characters, identify the lexemes in the stream, and categorize them into tokens. If the tokenization agent 203 finds an invalid token, it may report an error. Tokenization may include demarcating and classifying sections of a string of input characters. The resulting tokens may then be passed on for further processing by another data processing unit such as structure discovery agent 205.

In some embodiments, structure discovery agent 205 executes an algorithm that analyzes a collection of tokenized chunks and guesses what the top-level type constructor should be for the tokenized chunks. Based on this guess, structure discovery agent 205 partitions the chunks and recursively analyzes each partition to determine the best description for that partition.

In some cases, the term “token” is used interchangeably with “base type.” Data fields within a data source such as raw data 101 may be separated by ASCII punctuation symbols. Parenthetical syntax, including quotation marks, curly braces, square brackets, parentheses, and XML tags, may provide indications regarding the structure (i.e., format) of an ad hoc data file (e.g., raw data 101). Therefore, whenever tokenization agent 203 encounters such square brackets or other similar formatting characters, it may create a meta-token. In some embodiments, a meta-token may be a compound token that represents the pair of formatting characters and all the tokens within the pair of formatting characters. For example, the character sequence (i.e., syntax) “[5018]” may yield the meta-token “[*]” instead of the sequence of three simple tokens “[,” “Pint,” and “].” Upon structure discovery agent 205 encountering syntax with matching meta-tokens, it may “crack open” the meta-tokens and analyze the underlying structure. Accordingly, structure discovery agent 205 may effectively eliminate all meta-tokens during its analysis. Further, different data sources may use different tokenization strategies. Useful token definitions sometimes overlap or can be ambiguous. Further, while tokens are typically conveyed as regular expressions, regular expressions are not always easily used. Matching tokenization of an underlying data source can be important in structure discovery.

Users of format inference architecture 200 may utilize a default tokenization scheme skewed toward systems data; however, other users may specify a different scheme for their particular, specialized domain. For example, using a configuration file (not depicted in FIG. 2), computational biologists may want to add the DNA string “CATTGTT . . . ” to the default tokenization scheme found in a configuration file. In some embodiments, a configuration file is essentially a list of regular expressions pairs that may be accessed by components of structure inference module 114. Accordingly, components of structure inference module 114 may use such configuration files to generate part of a lexing system (e.g., tokenization agent 203). In some embodiments, such configuration files store base types and type definitions that may be incorporated into a data description (e.g., description 213 or XML description 225).

Following tokenization, structure discovery agent 205 conducts further analysis toward creating a format specification. As shown in FIG. 2, a collection of tokenized chunks is fed to structure discovery agent 205. In some embodiments, structure discovery agent 205 attempts to quickly find a candidate description “close” to a final solution. After finding a “close” candidate description, scoring function agent 207 analyzes the effectiveness of the candidate description. Using further processing by scoring function agent 207 and format refinement agent 209, structure inference module 114 conducts rewriting of the candidate description. Through such an iterative process, the candidate description is refined and transformed to produce a final description 213 that meets a predetermined set of parameters. The description may be sent to printer 211 for printing.

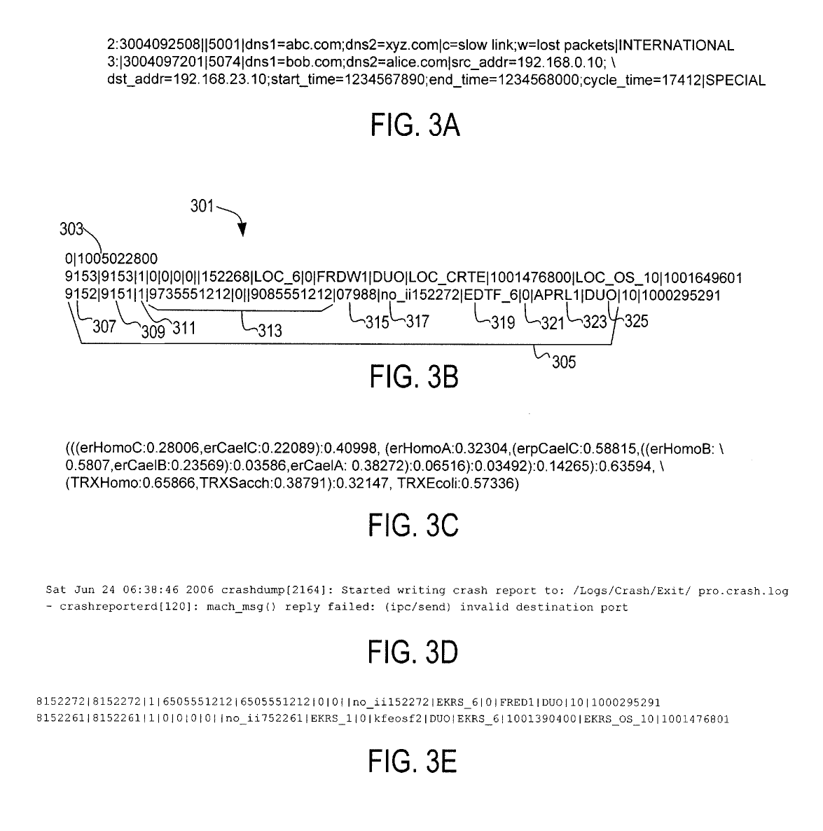

Formats used for ad hoc data may include ASCII, binary, and Cobol encodings, with both fixed and variable width records arranged in linear sequences and in tree-shaped hierarchies, as examples. Samples of some of these data formats appear in FIGS. 3A, 3B, 3C, 3D, and 3E. FIG. 3A contains two records from a network-monitoring application. As shown, each record has a different number of fields (delimited by ‘|’ (i.e., “pipe”)) and individual fields contain structured values (e.g., attribute-value pairs separated by ‘=’ and delimited by ‘; ’).

FIG. 3B contains another sample of ad hoc data that may be processed in accordance with disclosed embodiments. FIG. 3B includes sample data from a larger file for recording summaries of phone orders from a telephone company. As shown, data file 301 starts with a timestamp 303 followed by one record per phone service order. Each order consists of a header 305 and a sequence of events. As shown, the header 305 has 13 pipe-separated fields including: the order number 307, the telephone company's internal order number 309, the order version 311, telephone numbers 313 that may include four numbers associated with the order, the zip code 315 of the order, a billing identifier 317, the order type 319, a measure of the complexity of the order 321, a date field 323, and the source 325 of the order data. Many of these fields are optional, in which case nothing may appear between the pipe characters. The billing identifier 317 may not be available at the time of processing, in which case the system generates a unique identifier, and prefixes this value with the string “no ii” to indicate that the number was generated.

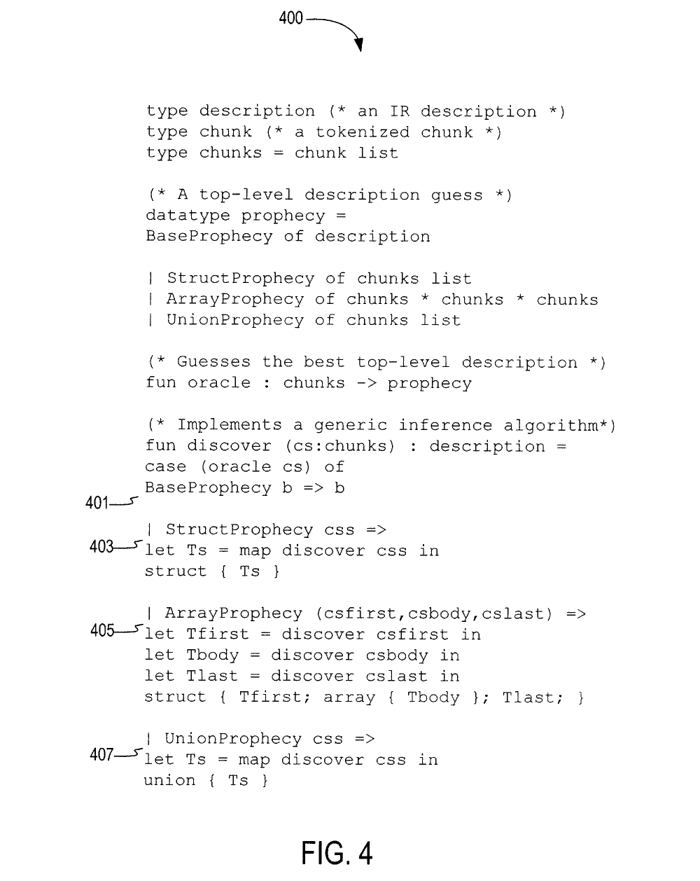

Structure discovery algorithms operated in accordance with disclosed embodiments may analyze a collection of tokenized chunks to guess what a top level constructor should be. Based on this guess, the algorithms may partition the chunks and recursively analyze each portion to determine the best description for that partition. FIG. 4 illustrates algorithm 400 that provides an outline of an exemplary procedure for such structure discovery in Pseudo-ML. Algorithm 400 may work in combination with an oracle function that may conjure one or more different prophecies regarding the structure of raw data (e.g., raw data 101 in FIG. 1 and FIG. 2).

As shown in FIG. 4, the BaseProphecy 401 reports that the top-level type constructor is a particular base type. The StructProphecy 403 specifies that the top-level description is a struct with k fields. It also specifies a list called “css” with k elements. The n-^{th} element in css is the list of chunks corresponding to the n-^{th} field of the struct. The oracle derives these chunk lists from its original input. More specifically, if the oracle guesses there will be k fields, then each original chunk is partitioned into k pieces. The n-^{th} piece of each original chunk is used to recursively infer the type of the n-^{th} field of the struct.

ArrayProphecy 405 specifies that the top-level structure involves an array. However, predicting exactly where an array begins and ends may be difficult, even for a well-written oracle. Consequently, algorithm 400 generates a three-field struct, where the first field allows for slop prior to the array, the middle field is the array itself, and the last field allows for slop after the array. If the slop turns out to be unnecessary, the rewriting rules in the next phase are designed to eliminate it.

Finally, as shown in FIG. 4, the UnionProphecy 407 specifies that the top-level structure is a union type with k branches. Like StructProphecy 403, the UnionProphecy 407 carries a chunks list, with one element for each branch of the union. The algorithm uses each element to recursively infer a description for the corresponding branch of the union. Intuitively, the oracle produces the union chunks list by “horizontally” partitioning the input chunks, whereas it partitions struct chunks “vertically” along field boundaries.

As an example, recall the data from FIG. 3D. Assuming a chunk is a line of data and that [*] and (*) are meta tokens, the two chunks for the data in FIG. 3D consist of the token sequences:

Pdate ’ ’ Ptime ’ ’ Pint ’ ’ Palpha [*] ’:’ ...
’-’ ’ ’ Palpha [*] ’:’ ’ ’ Palpha (*) ’ ’ ...

Given these token sequences, the oracle will predict that the top-level type constructor is a struct with three fields: one for the tokens before the token [*], one for the [*] tokens themselves, and one for the tokens after the token [*]. The oracle then divides the original chunks into three sets as follows:

| | |
|---|---|
| Pdate ’ ’ Ptime ’ ’ Pint ’ ’ Palpha | set 1 |
| ’-’ ’ ’ Palpha | |
| [*] | set 2 |
| [*] | |
| ’:’ ... | set 3 |
| ’:’ ’ ’ Palpha (*) ’ ’ ... | |

On recursive analysis of set 1, the oracle again suggests a struct is the top-level type, generating two more sets of chunks:

| | |
|---|---|
| Pdate ’ ’ Ptime ’ ’ Pint ’ ’ | set 4 |
| ’-’ ’ ’ | |
| Palpha | set 5 |
| Palpha | |

Because every chunk in set 5 contains exactly one base type token, the recursion bottoms out with the oracle claiming it has found the base type “Palpha”. When analyzing set 4, the oracle detects insufficient commonality between chunks and decides the top-most type constructor is a union. It partitions set 4 into two more sets, with each group containing only one chunk (either {Pdate ‘ ’ . . . } or {‘-’ ‘ ’}). The algorithm analyzes the first set to determine the type of the first branch of the union and the second set to determine the second branch of the union. With no variation in either branch, the algorithm quickly discovers an accurate type for each.

Accordingly, a structure discovery agent (e.g., structure discovery agent 205 in FIG. 2) may analyze the data in FIG. 3D to completely discover the type of the data in set 1. To analyze set 2, the algorithm 400 (FIG. 4) cracks open the [*] meta-tokens to recursively analyze the underlying data. This process yields “struct {‘[’; Pint; ‘]’;}”. Similarly, analysis of set 3 proceeds.

As another example, consider the data from FIG. 3E. As shown, the chunks have the following structure:

Pint ’|’ Pint ’|’ ... ’|’ Pint ’|’ Pint
Pint ’|’ Pint ’|’ ... ’|’ Palpha Pint ’|’ Pint

In an exemplary embodiment, the oracle prophecies that the top-level structure involves an array and partitions the data into sets of chunks for the array preamble, the array itself, and the array postamble. It does this partitioning to cope with potential “fence-post” problems in which the first or the last entry in an array may have a slightly different structure. As shown, the preamble chunks all have the form {Pint ‘|’ } while the postamble chunks all have the form {Pint}, so the algorithm easily determines their types. The algorithm discovers the type of the array elements by analyzing the residual list of chunks

Pint ’|’
...
Pint ’|’
Pint ’|’
...
Palpha Pint ’|’

The oracle constructs this chunk list by removing the preamble and postamble tokens from all input chunks, concatenating the remaining tokens, and then splitting the resulting list into one chunk per array element. It does this splitting by assuming that the chunk for each array element ends with a ‘|’ token.

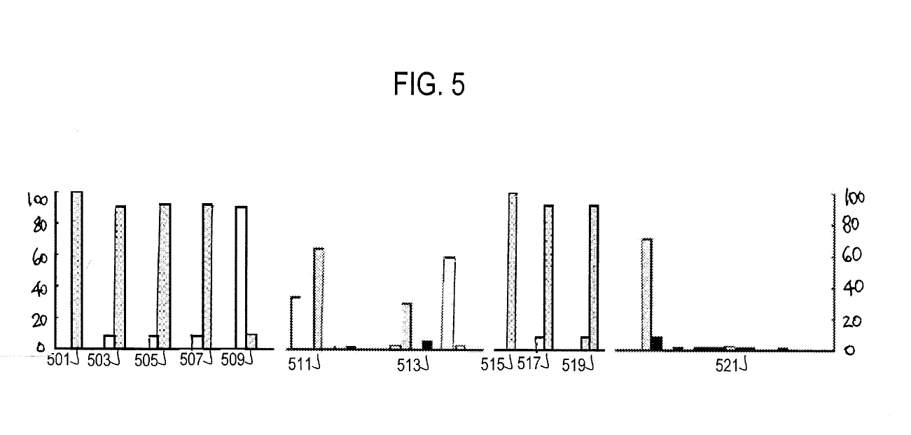

In accordance with disclosed embodiments, to generate the required prophecy for a given list of chunks, the oracle may compute a histogram of the frequencies of all tokens appearing in the input. More specifically, the histogram for token t plots the number of chunks (on the y-axis) having a certain number of occurrences of the token (on the x-axis). FIG. 5 presents a number of histograms computed during analysis of the data in FIG. 3D and FIG. 3E.

Intuitively, tokens associated with histograms with high coverage, meaning the token appears in almost every chunk, and narrow distribution, meaning the variation in the number of times a token appears in different chunks is low, are good candidates for defining structs. Similarly, histograms with high coverage and wide distribution are good candidates for defining arrays. Finally, histograms with low convergence or intermediate width likely represent tokens that form part of a union.

Referring to FIG. 5, histogram 501 is a strong struct candidate because it has a single column that covers 100% of the records. Indeed, this histogram corresponds to the [*] token in FIG. 3D. In response to detecting such a histogram, embodied oracles are designed to prophecy a struct and partition the input chunks according to the associated token. As shown in FIG. 5, other top-level histograms for the data in FIG. 3D contain variations and hence are less certain indicators of data source structure (i.e., data source format).

As shown in FIG. 5, histograms 501, 503, 505, 507, 509, 511, and 513 are generated from top-level analysis of tokens from the data in FIG. 3D. The corresponding tokens are [*] for 501, Pint for 503, PDate for 505, PTime for 507,—for 509, Palpha for 511, and Pwhite for 513. Histograms 515, 517, and 519 correspond to Palpha, Pint, and Pwhite, respectively, which are generated from analysis of the data from FIG. 3D from set 1 above (the second level of recursion). Histogram 521 is generated from top-level analysis of the pipe (|) token from the data in FIG. 3E.

As another example, consider FIG. 5's top-level histograms 511, 503, and 513 for tokens Palpha, Pint and Pwhite, respectively. Compared with corresponding histograms 515, 517, and 519 computed for the same tokens from chunk set 1 defined previously, the histograms for chunk set 1 have far less variation than the corresponding top-level histograms. In particular, as shown, histogram 515 for token Palpha is a perfect struct histogram whereas histogram 511 for token Palpha contains a great deal of variation. This example illustrates a benefit of a divide-and-conquer algorithm for embodied oracles, wherein if the oracle can identify even one token at a given level as defining a good partition for the data, the histograms for the next level down become substantially sharper and more amenable to analysis. Histogram 521 illustrates a classic pattern for tokens involved in arrays—it has a very long tail. Indeed, the | token in the data in FIG. 3E does act like a separator for fields of an array.

In some embodiments, when an oracle is given a list of chunks, the oracle prophecies (i.e., creates a prophecy) as follows: First, the oracle prophecies a base type when each chunk contains the same simple token. If each chunk contains the same meta-token (e.g., parenthesis) the oracle prophecies a struct with three fields: one for the left parenthesis, one for the body, and one for the right parenthesis. Otherwise, if each chunk does not contain the same meta-token, normalized histograms are computed for the input and group. For example, using agglomerative clustering, a histogram h₁ belongs to group G provided there exists another histogram h₂ in G such that a function S(h₁ bar∥h₂ bar)<ClusterTolerance, where ClusterTolerance is a parameter of the algorithm. It is not required that all histograms in a cluster have precisely the same histogram, to allow for errors in the data. A histogram dissimilar to all others may form its own group. To this end, a ClusterTolerance of 0.01 may be effective.

In some embodiments, a determination of whether a struct exists is made by first ranking groups by the minimum residual mass of all the histograms in each group. Embodiments may automatically find the first group in this ordering with histograms h satisfying the following criteria:
rm(h)<MaxMass
coverage (h)>MinCoverage

Constants “MaxMass” and “MinCoverage” are parameters of the algorithm. This process favors groups of histograms with high coverage and narrow distribution. If histograms h₁, . . . , hₙ from group G satisfy the struct criteria, the oracle will prophecy some form of struct. It uses the histograms h₁, . . . , hₙ and the associated tokens t₁, . . . , tₙ to calculate the number of fields and the corresponding chunk lists. Embodiments may call t₁, . . . , tₙ the identified tokens for the input. Intuitively, for each input chunk, the oracle may put all tokens up to but not including the first token t from the set of identified tokens into the chunk list for the first field. In addition, the oracle may put t in the chunk list for the second field and put all tokens up to the next identified token into the chunk list for the third field, and so on. Identified tokens need not appear in the same order in all input chunks, nor must they all appear at all. To handle some variations, the oracle may prophecy a union instead of a struct, with one branch per token ordering and one branch for all input chunks that do not have the full set of identified tokens.

Following structure discovery, an information theoretic scoring function may be used to assess the quality of an inferred description and to decide whether to apply rewriting rules to refine candidate descriptions. These steps may be carried out by scoring function agent 207 and format refinement agent 209, as shown in FIG. 2. Intuitively, a good description is one that is both compact and precise. There are likely trivial descriptions of any data source that are highly compact (e.g., the description that says the data source is a string terminated by end of file) or perfectly precise (e.g., the data itself abstracts nothing and therefore serves as its own description). A good scoring function balances these opposing goals. As is common in machine learning, a scoring function may be defined based on the Minimum Description Length Principle (MDL), which states that a good description is one that minimizes the cost (in bits) of transmitting the data. Mathematically, if T is a description and d₁, . . . , dₖ are representations of the k chunks in a training set, parsed according to T, then the total cost in bits is:

cost(T, d₁, . . . , dₖ)=CT(T)+CD(d₁, . . . , dₖ|T)

CT(T) is the number of bits to transmit the description and CD(d₁, . . . , dₖ |T) is the number of bits to transmit the data given the description. Intuitively, the cost in bits of transmitting a description is the cost of transmitting the sort of description (e.g., struct, union, enum, etc.) plus the cost of transmitting all of its sub-components. For example, the cost of transmitting a struct type CT(struct{T₁; . . . ; Tₖ;}) is:

$$card + {\sum }_{i = 1}^{k} CT ( {T}_{i} )$$

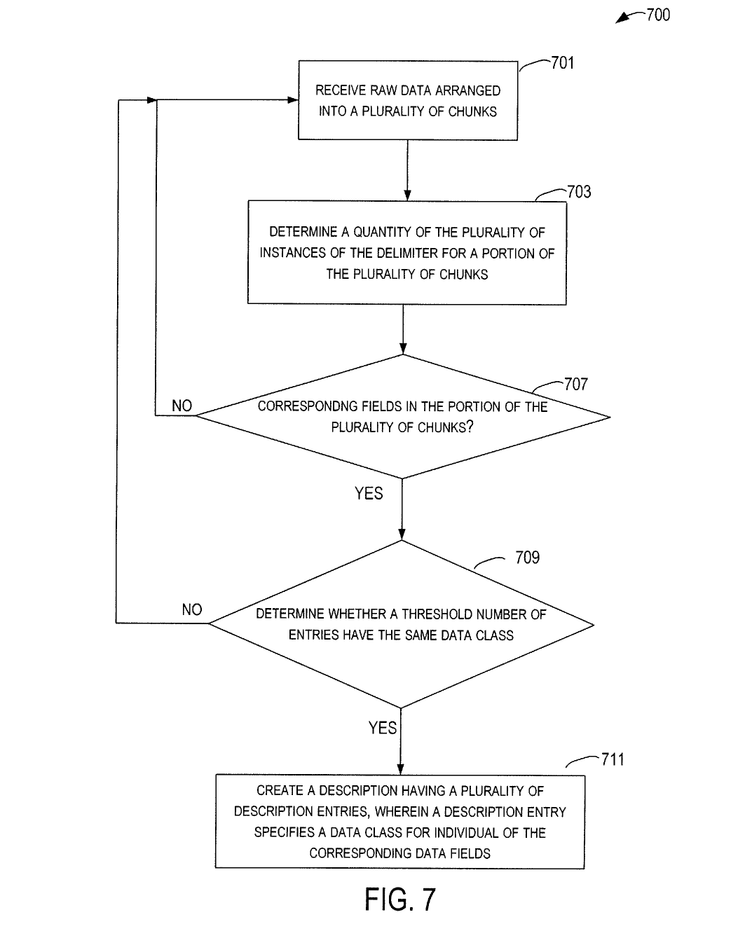

In the above equation, “card” is the log of the number of different sorts of type constructors. Other recursive cost functions may be defined and utilized. In addition, the published paper entitled “From Dirt to Shovels: Fully Automatic Tool Generation from Ad Hoc Data” by Kathleen Fisher, et al., has further details regarding recursive cost functions, including the paper's FIG. 7, which is incorporated by reference and discusses the cost of transmitting data relative to selected rules.

In addition to the determination and scoring of a format specification, structure refinement may be undertaken by disclosed embodiments to improve the format specification. The goal of the structure-refinement phase is to improve the structure produced by the structure discovery phase. Generally, structure-refinement relates to generalized searching through the description space starting with the candidate produced by structure discovery. The objective of the search is to find the description that minimizes the information-theoretic scoring function. As shown in FIG. 2, structure refinement is performed in an iterative process between scoring function agent 207 and format refinement agent 209 to result in a description that produces an optimized score.

In some embodiments, format refinement includes rewriting the description based on a set of predetermined rewriting rules. Rewriting rules can be generally defined as T=>T′, if some constraint p(T) is satisfied, where T is a type in the candidate description and T′ is its replacement after the rewriting. Some rules are unconditional and thus free of constraints. There are at least two kinds of rewriting rules: (1) data-independent rules that transform a type based exclusively on the syntax of the description; and (2) data-dependent rules that transform a type based both on the syntax of the description and on properties of the training data parsed by type T. In general, the data-independent rules try to rearrange and merge portions of the description while the data dependent rules seek to identify constant fields and enumerations, and to establish data dependencies between different parts of the description.

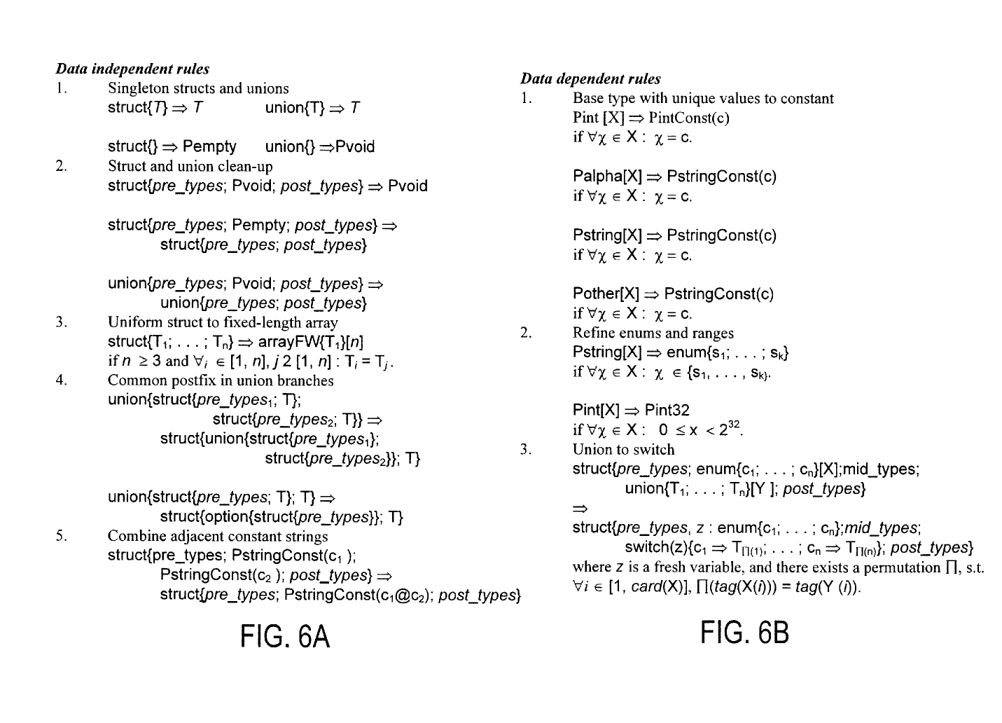

FIG. 6A and FIG. 6B present a selection of rewriting rules that may be used in the refinement phase. Many rules are omitted or simplified for clarity and succinctness. When T[[X]] appears in a pattern on the left-hand side of a rewriting rule, X is bound to the set of data representations resulting from using T to parse the appropriate part of each chunk from the training set. Furthermore, let card(X) be the cardinality of the set X and let X(i) be the data representation resulting from parsing the n-^{th} chunk in the training set. Finally, given a union value in inⱼ(v), then tag(inⱼ(v)) may be defined as j.

In illustrative embodiments, the core of the rewriting system is a recursive and depth-first search procedure. “Depth-first” generally means the algorithm considers the “children” of each structured type before considering the structure itself. When refining a type, the algorithm selects the rule that would minimize the information-theoretic score of the resulting type and applies this rule. This process may repeat until no further reduction in the score is possible, at which point one can consider that resulting type T is stable.

In an illustrative embodiment, the rewriting phase applies the algorithm given below three times in succession:

(* rewriting rules *)
type rule : description −> description
val rules : rule list
(* measure the score for a type *)
fun score : description −> float
(* find the type with best score from a list *)
fun best: description list −> description
(* improve the given type by one rewriting rule *)
fun oneStep (T:description) : description =

| let all = map (fn rule => rule T) rules in | |
|---|---|
| let top = best all | in |

if (score top) < (score T) then oneStep top
else T

(* main function to refine an IR description *)
fun refine (T:description) : description =

let T’ = case T of

base b => b
| struct { Ts } => struct { map refine Ts }
| union { Ts } => union { map refine Ts }
| switch x of { vTs } =>

switch x of
{ map (fn (v, t) => (v, refine t)) vTs }

| array { T } =>

array { refine T }

| option { T } => option { refine T } in

one Step T’

The above algorithm is an illustrative, generic, local optimization algorithm written in Pseudo-ML. In an embodiment, the first time the algorithm is applied, the algorithm quickly simplifies the initial candidate description using only data-independent rules such as those illustrated in 6A. The second time the algorithm is applied, it uses the data-dependent rules (e.g., those in FIG. 6B) to refine base types to constant values and enumerations, etc., and to introduce dependencies such as switched unions. This stage may require that the value-space analysis is described next. The third time, the algorithm reapplies the data-independent rules (e.g., those found in FIG. 6A) because some stage-two rewritings (such as converting a base type to a constant) enable further data-independent rewritings.

In some embodiments, value-space analysis may be performed prior to applying data-dependent rules. This analysis first generates a set of relational tables from the input data. Each row in a table corresponds to an input chunk and each column corresponds to either a particular base type from the inferred description or to a piece of metadata from the description. Examples of meta-data include the tag number from union branches and the length of arrays. In illustrative embodiments, a set of relational tables is generated rather than a single table. This is because the elements of each array may occupy their own separate table. On the other hand, a description with no arrays likely will have only one associated table. In some embodiments, every column of the table is analyzed to determine properties of the data in that column such as constancy and value range.

A multitude of algorithms may be employed to find intercolumn properties, for example those properties that identify functional dependencies between columns in relational data. In some embodiments, to prevent false positives when invoked with insufficient data, an algorithm may focus on computing binary dependencies. In this way, the results of dependency analysis can be used to identify switched unions and fixed-size arrays.

The published paper entitled “From Dirt to Shovels: Fully Automatic Tool Generation from Ad Hoc Data” by Kathleen Fisher, et al., has detailed discussions regarding the refinement process, and these discussions are incorporated by reference.

After generation and refinement, embodied systems may convert the internal representation into a syntactically correct PADS description for feeding to a PADS compiler and producing a collection of scripts that conveniently package the freshly generated libraries with the PADS run-time system and tools. At the end of this process, users may be provided a number of programming libraries and a suite of tools at their disposal for processing raw data. Among the suite of tools may be an XML converter, which allows users to write arbitrary XQueries over the data source or to convert the raw data to XML for use by other software. Other useful tools include accumulator tools, converters to translate data into a form suitable for loading into a relational database or spreadsheet, and custom graphing tools that push data into a plotter for data visualization.

FIG. 7 illustrates methodology 700 for determining data structures in accordance with disclosed embodiments. As shown, block 701 relates to receiving raw data arranged into a plurality of chunks. A chunk is a unit of repetition in a data source. For example, a data source may be arranged on a line-by-line basis and each line would be considered a chunk. In some embodiments, the plurality of chunks includes a plurality of fields that are separated by a plurality of instances of a delimiter. After this chunking step, disclosed embodiments may perform tokenization to break each chunk into a series of simple tokens. To this end, block 703 relates to determining a quantity of the plurality of instances of the delimiter for a portion of the plurality of chunks. If a particular delimiter occurs a consistent number of times in all or a majority of chunks, then disclosed embodiments may estimate that the delimiter is used within the raw data to separate tokens in each chunk. After tokenization, disclosed methods perform structure discovery by, for example, analyzing a collection of tokenized chunks and estimating what the top-level type constructor should be for the tokenized chunks. Accordingly, in block 707, a determination is made whether there are corresponding fields in the portion of the plurality of chunks. In operation, a structure discovery agent performing block 707 may determine that the third field in 90% of all chunks (i.e., a portion of the total number of chunks analyzed) has a date. In addition, the first field in 99% of all chunks may contain a text string. Therefore, 90% of chunks have a third field that corresponds to the third field of other chunks by having a date and 99% of chunks have a first field that corresponds to the first field of other chunks by having a text string. In such a case, a constructor (e.g., “text string”) may be used to describe the third field in the raw data and another constructor (e.g., “date”) may be used to describe the first field. In this way, a structure discovery agent may accurately derive a description of tokens within raw data. Embodied structure discovery agents often act recursively to analyze tokens. In some embodiments, if corresponding top-level type constructors are not discovered, block 707 returns to block 701 to receive more raw data if it is available. Alternatively, a description may be generated that indicates there are no corresponding fields in the portion of the plurality of chunks. If there are corresponding fields in the portion of the plurality of chunks in block 707, methodology 700 progresses to block 709 for determining whether a threshold number of entries have the same data class. In some embodiments, the threshold number of entries are from individual fields of a portion of the corresponding fields. As shown, block 711 relates to creating a description (e.g., description 213 in FIG. 2) having a plurality of description entries. In illustrative embodiments, each description entry specifies a data class for individual data fields of the corresponding data fields from block 707.

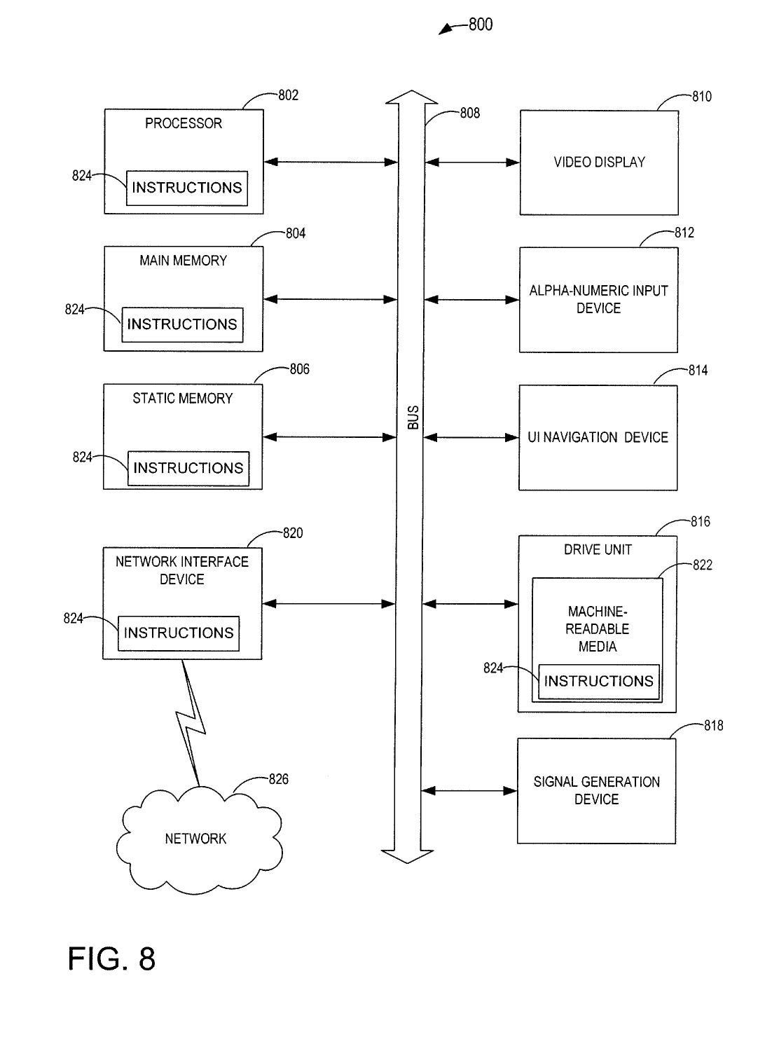

FIG. 8 illustrates in block diagram form a data processing system 800 within which a set of instructions may operate to perform one or more of the methodologies discussed herein. Data processing system 800 may operate as a standalone device or may be connected (e.g., networked) to other data processing systems. In a networked deployment, data processing system 800 may operate in the capacity of a server (e.g., application server) or a client data processing system in a server-client network environment, or as a peer computer in a peer-to-peer (or distributed) network environment. While only a single data processing system is illustrated, the term “data processing system” shall also be taken to include any collection of data processing systems that individually or jointly execute a set (or multiple sets) of instructions to perform any one or more of the methodologies discussed herein.

As shown, data processing system 800 includes a processor 802 (e.g., a central processing unit, a graphics processing unit, or both), a main memory 804, and a static memory 806 that may communicate with each other via a bus 808. In some embodiments, the main memory 804 and/or the static memory 806 may be used to store the indicators or values that relate to multimedia content accessed or requested by a consumer. Data processing system 800 may further include a video display unit 810 (e.g., a television, an LCD or a CRT) on which to display content such as descriptions generated by embodiments. Data processing system 800 also includes an alphanumeric input device 812 (e.g., a keyboard or a remote control), a user interface (UI) navigation device 814 (e.g., a remote control or a mouse), a disk drive unit 816, a signal generation device 818 (e.g., a speaker) and a network interface device 820. The input device 812 and/or the UI navigation device 814 (e.g., a remote control) may include a processor (not shown), and a memory (not shown). The disk drive unit 816 includes a machine-readable medium 822 that may have stored thereon one or more sets of instructions and data structures (e.g., instructions 824) embodying or utilized by any one or more of the methodologies or functions described herein. The instructions 824 may also reside, completely or at least partially, within the main memory 804, within static memory 806, within network interface device 820, and/or within the processor 802 during execution thereof by the data processing system 800.

The instructions 824 may further be transmitted or received over a network 826 via the network interface device 820 utilizing any one of a number of n transfer protocols (e.g., HTTP). While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine (i.e., data processing system) and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Disclosed embodiments may include algorithms that automatically infer the structure of ad hoc data sources. In some embodiments, the products of such multi-phase algorithms are format specifications that are compatible with the PADS data description language. The PADS data description language is a data description language for processing ad hoc data. Programmers may use disclosed embodiments to generate PADS descriptions (and other inference algorithms) that may be used with PADS or other data description languages for custom data analysis. In addition, disclosed embodiments may be used to generate a suite of useful data processing tools, including ones that print or display data in a form easily processed by humans. Further, disclosed inference algorithms may be used to generate printing libraries and parsing libraries for ad hoc data. PADS descriptions may be passed through a PADS compiler to create format-dependent modules that, when linked with format-independent algorithms for analysis and transformation, result in fully functional tools.

Generating a data description from the ad hoc data, in accordance with disclosed embodiments, may be an iterative process in which the performance of draft data descriptions is graded. Accordingly, a data description (e.g., a PADS description) may be modified and used in a data compiler (e.g., a PADS compiler) until an optimal data description is achieved. Automated systems generate data descriptions and refine them to prevent analysts from having to manually draft and test data descriptions, which may take hours or days. In addition to optimizing the data descriptions, some disclosed embodiments may grade the accuracy of a data description.

PADS is a data description language that may provide domain-specific descriptions (i.e., format specifications) to be written for specifying the structure and expected properties of ad hoc data sources, regardless of whether they are ASCII, binary, Cobol or a mixture of formats. These specifications, which may resemble extended type declarations from conventional programming languages, may be compiled into a suite of programming libraries. Example programming libraries include parsers, printers, and end-to-end data processing tools, including an XML-translator, a query module, a simple statistical analyzer, and the like. Hence, a benefit of using PADS is that a single declarative description may be used to automatically generate many useful data processing tools. From such descriptions, a PADS compiler generates libraries and tools for manipulating the data, including parsing routines, statistical profiling tools, and translation programs.

PADS may be used to produce known data formats such as XML or others that may be used to process and load ad hoc data into a relational database. As is commonly known, XML is a general-purpose markup language used in software-based systems. XML allows users to create customized tags and facilitates sharing of structured data across different information systems included the Internet. XML may be used to encode documents and serialize data. Some disclosed systems allow ad hoc data to be converted quickly into XML without much, if any, human intervention. Upon conversion, data analysts may utilize a full collection of existing, XML-related tools to process the data. If XML is not the desired target format, then disclosed systems may produce a parser or a file that may be used to print data in a format that is easily read by humans (i.e., the data may be “pretty printed”). In addition, disclosed systems may automatically generate a collection of library functions for a PADS compiler. For illustrative purposes, examples disclosed herein may be explained with reference to XML; however, this is not meant as limiting. Other languages, formats, and protocols similar to XML may be used in accordance with the subject matter of the appended claims.

A PADS compiler typically requires a PADS description. Such descriptions are flexible enough to describe data formats in encodings such as ASCII, binary and Cobol, as examples. From a PADS description, the PADS compiler generates a library for manipulating the associated data source. A PADS/MetaLanguage (PADS/ML) compiler generates an ML library, while PADS/C generates a C library. Data analysts can use the generated libraries directly, or they can use a suite of auxiliary tools to summarize the data, validate it, or translate the data into XML. Additionally, the data may be reformatted into a form suitable for loading into relational databases. PADS may not be particularly suited to parse XML data or data already in a relational database; however, such data may be processed with XML or database-specific tools.

In some embodiments, the disclosed structure inference functionality produce a PADS/ML. PADS/ML may function as a domain-specific language to improve the productivity of data analysts that must deal with ad hoc data. To use the PADS system, analysts may describe their data in the PADS/ML language, capturing both the physical format of the data and any expected semantic constraints. A PADS/ML compiler can convert the description into a suite of robust, end-to-end data processing tools and libraries specialized to the format. As the analysts' data sources evolve over time, the analysts may update the high-level descriptions and recompile to produce updated tools. PADS/ML is intended to provide dependent, polymorphic recursive data types, layered on top of a collection of base types, to specify the syntactic structure and semantic properties of data formats. Together, these features enable analysts to write concise, complete, and reusable descriptions of their data. Examples presented herein may be described in terms of PADS/ML; however, it is intended that the subject matter of the appended claims also cover other data description languages.

By describing data in PADS/ML, a developer can produce automatically a collection of data analysis and processing tools from each description. A PADS/ML compiler generates from each description a parser and a printer for the associated data source. The parser maps raw data into two data structures: a canonical representation of the parsed data and a parse descriptor, a meta-data object detailing properties of the corresponding data representation. Parse descriptors provide applications with programmatic access to errors detected during parsing. The printer inverts the process, mapping internal data structures and their corresponding parse descriptors back into raw data. In addition to generating parsers and printers, the PADS/ML framework permits developers to add format-independent tools without modifying the PADS/ML compiler by specifying tool generators. Such generators need only match a generic interface, specified as an ML signature. Correspondingly, for each PADSAML description, the PADSAML compiler generates a meta-tool (a functor) that takes a tool generator and specializes it for use with the particular description.

Accordingly, a PADS/ML description may specify the physical layout and semantic properties of an ad hoc data source. These descriptions are composed of differing types: base types describe atomic data, while structured types describe compound data built from simpler pieces. Examples of base types include ASCII-encoded, 8-bit unsigned integers (Puint8) and 32-bit signed integers (Pint32), binary 32-bit integers (Pbint32), dates (Pdate), strings (Pstring), zip codes (Pzip), phone numbers (Pphone), and IP addresses (Pip). Semantic conditions for such base types include checking that the resulting number fits in the indicated space, i.e., 16-bits for Pint16. Base types may be parameterized by ML values. This mechanism reduces the number of built-in base types and permits base types to depend on values in the parsed data. For example, the base type Puint16_FW(3) specifies an unsigned two byte integer physically represented by exactly three characters, and the base type Pstring takes an argument indicating the terminator character, i.e., the character in the source that follows the string. To describe more complex data, PADS/ML provides a collection of type constructors derived from the type structure of functional programming languages like Haskell and ML.

While the disclosed systems may be described in connection with one or more embodiments, it is not intended to limit the subject matter of the claims to the particular forms set forth. On the contrary, it is intended to cover such alternatives, modifications and equivalents as may be included within the spirit and scope of the subject matter as defined by the appended claims.

What is claimed is:

1. An application server enabled to:
analyze data to infer a structure of the data; and
generate a format specification based on the inferred structure of the data,
wherein the format specification complies with a data description language.

2. The application server of claim 1, wherein the application server is enabled with:
a tokenization agent for discovering how a plurality of fields are defined within each of a portion of a plurality of chunks that comprise the data; and
a structure discovery agent for determining characteristics related to a portion of the plurality of fields.

3. The application server of claim 2, wherein the application server is further enabled with:
a scoring function agent for grading the format specification; and
a format refinement agent for iteratively:
modifying the format specification into a version of a modified format specification;
presenting the version of the modified format specification to the scoring function agent for analysis of the version; and
determining an optimal format specification based on analysis by the scoring function agent.

4. The application server of claim 1 further enabled to:
compile the format specification to produce a format-dependent executable module.

5. The application server of claim 4, wherein the format-dependent executable module converts raw data into Extensible Markup Language.

6. The application server of claim 1, wherein the format specification is suitable for use by a data parser.

7. The application server of claim 1, wherein the format specification is suitable for use by a data printer.

8. The application server of claim 4, wherein the format-dependent executable module is suitable for use by a data description compiler.

9. The application server of claim 8, wherein the data description compiler is a Processing Ad Hoc Data System (PADS) compiler.

10. The application server of claim 9, wherein the data includes ASCII data.

11. A method of determining data structures, the method comprising:
receiving raw data arranged into a plurality of chunks that include a plurality of fields that are separated by a plurality of instances of a delimiter;
determining a quantity of the plurality of instances of the delimiter for a portion of the plurality of chunks;
determining whether there are corresponding fields in the portion of the plurality of chunks;
if there are corresponding fields in the portion of the plurality of chunks,
determining whether a threshold number of entries have the same data class, wherein the threshold number of entries are from individual fields of a portion of the corresponding fields; and
creating a description having a plurality of description entries, wherein a description entry specifies a data class for individual of the corresponding data fields.

12. The method of claim 11, wherein the description includes a description entry specifying a data class for any of the corresponding data fields that have a threshold number of entries having the same data class.

13. The method of claim 11, wherein determining whether a threshold number of entries have the same data class includes determining on a per-field basis whether each chunk in the portion of the plurality of chunks has a field entry from a data class.

14. The method of claim 13, wherein the description complies with a format description language.

15. The method of claim 14, wherein if each chunk in the portion of the plurality of chunks does not have a field entry from a data class, the method further comprises:
determining whether each chunk in the portion of the plurality of chunks has a field entry corresponding to a select plurality of data classes, wherein if each chunk in the portion of the plurality of chunks has a field entry corresponding to a select plurality of data classes:
creating a union in the description that indicates the select plurality of data classes.

16. The method of claim 14, wherein the method further comprises:
scoring the description;
iteratively scoring the description and reformatting the description to result in an optimized description, wherein the optimized description meets a threshold value.

17. The method of claim 16, wherein the optimized description results from reducing a length of the description to meet the threshold value.

18. The method of claim 13, wherein the data class is integer.

19. The method of claim 13, wherein the data class is floating point.

20. The method of claim 13, wherein the data class is string.

21. The method of claim 11, wherein determining whether a threshold number of entries have the same data class includes parsing to determine the entry's data class.

22. A computer program product stored on a computer readable media, the computer program product for determining data formats, the computer program product having instructions operable for:
lexing raw data to result in a plurality of tokens, wherein the raw data is understood to be arranged in a plurality of chunks, wherein each chunk contains a plurality of corresponding fields;
on a field-by-field basis for a portion of the plurality of chunks, summing the occurrence counts of a token to result in a plurality of sums;
determining from the plurality of sums whether each of the portion of the plurality of chunks has a threshold number of occurrence counts;
if each portion of the plurality of chunks has a first threshold number of occurrence counts, including in a description a first indication that the token is a delimiter;
determining for the portion of the plurality of chunks whether a second threshold number of occurrence counts occur within corresponding entries of a field, wherein each corresponding entry is from a different chunk of the portion of the plurality of chunks, and
if a second threshold number of occurrence counts of a data class occur within corresponding entries of the field, including in the description a second indication that entries in the field are from the data class.

23. The computer program product of claim 22 further having instructions operable for:
scoring the description; and
iteratively scoring the description and reformatting the description to result in an optimized description, wherein the optimized description meets a third threshold value.

24. The computer program product of claim 23, wherein if a second threshold number of instances of a data class does not occur within corresponding entries of a field, the computer program product further has instructions operable for:
determining whether corresponding entries of a field belong to a selected plurality of data classes; and
if corresponding entries of the field belong to the selected plurality of data classes, creating a union in the description indicating the union and the selected plurality of data classes.
